(19) United States
(12) Patent Application Publication
(10) Pub. No.: US 2011/0208428 A1
(43) Pub. Date: Aug. 25, 2011

(54) NAVIGATION APPARATUS

(76) Inventors: Tsutomu Matsubara, Tokyo (JP); Tsuyoshi Sempuku, Tokyo (JP); Mitsuo Shimotani, Tokyo (JP); Masako Ota, Tokyo (JP); Takashi Sadahiro, Tokyo (JP)

(21) Appl. No.: 13/125,479

(22) PCT Filed: Nov. 24, 2009
(86) PCT No.: PCT/JP2009/006306

§ 371 Date: Apr. 21, 2011

(30) Foreign Application Priority Data
Dec. 17, 2008 (JP) 2008-321074

(51) Int. Cl. G01C 21/00

(52) U.S. Cl. 701/208

(57) ABSTRACT

A navigation apparatus is provided which displays an own-vehicle driving condition without making it difficult to view a map display. The navigation apparatus includes own-vehicle location determination means 1 that determines a location of an own vehicle; a map database 11 having map data recorded therein; vehicle data acquisition means 6 that acquires vehicle data; a displaying means 5 that displays on the map data an own-vehicle mark indicating the location of the own-vehicle; and data processing means 13 that determines a driving condition using the vehicle data, to thereby vary the own vehicle mark, wherein the vehicle driving condition is represented by means of the own vehicle mark.

### TECHNICAL FIELD

The present invention relates to a navigation apparatus mounted on a vehicle, which displays a driving condition of the vehicle.

### BACKGROUND ART

In recent years, a navigation apparatus not only displays a vehicle's present location on a map and provide a route guidance to a destination location of the vehicle, but also displays a fuel consumption rate as a pop-up window superimposed on the map, because of increased public awareness of energy-saving driving in consideration of environmental problems and energy resources (refer to Patent Document 1, for instance).

### [Prior Art Document]

### [Patent Document]

### [Patent Document 1]

Japanese Unexamined Patent Publication No. 2008-180576 (page 6, FIG. 2)

### DISCLOSURE OF INVENTION

### Problem that the Invention is to Solve

In conventional fuel consumption display apparatuses and navigation apparatuses, a fuel consumption rate indicative of a driving condition is displayed as a pop-up window. Therefore, a problem is presented in that a map is partially obstructed by the pop-up window, thus resulting in a map display that is difficult to view.

The present invention is directed to overcome the above problem, and an object of the invention is to provide a navigation apparatus that displays an own-vehicle driving condition on its screen without making it difficult to view a map display.

### Means for Solving the Problem

A navigation apparatus comprises own-vehicle location determination means that determines a location of an own vehicle; a map database having map data recorded therein; vehicle data acquisition means that acquires vehicle data; displaying means that displays on the map data an own-vehicle mark indicating a location of the own vehicle; and data processing means that determines a driving condition using the vehicle data, to thereby vary the own-vehicle mark, wherein a vehicle driving condition is represented by means of the own vehicle mark.

### Advantageous Effects of the Invention

According to the present invention, since an own-vehicle mark is varied in accordance with the driving condition, the vehicle driving condition can be recognized without making it difficult to view a map display, thereby providing a navigation apparatus having enhanced convenience.

### BRIEF DESCRIPTION OF DRAWINGS

FIG. 1 is a block diagram illustrating Embodiment 1 through Embodiment 4 according to the present invention;

FIG. 2 is an example of a screen display illustrating Embodiment 1 according to the present invention;

FIG. 3 is another example of the screen display illustrating Embodiment 1 of according to the present invention;

FIG. 4 is a flow diagram showing operations of Embodiment 1 through Embodiment 4 of the present invention;

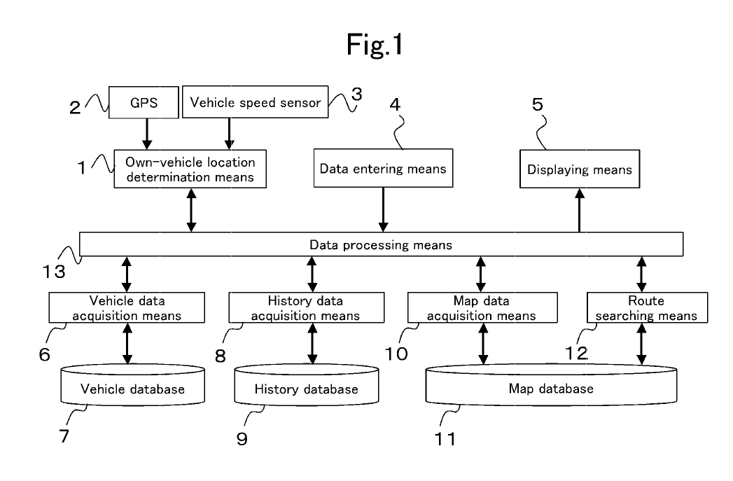

FIG. 1 is an example of a screen display according to Embodiment 2 of the present invention;

FIG. 6 is a flow diagram illustrating an operation of Embodiment 2 according to the present invention;

FIG. 7 is an example of a screen display illustrating Embodiment 3 of the present invention;

FIG. 8 is a flow diagram showing an operation according to Embodiment 3 of the present invention;

FIG. 9 is an example of a screen display showing Embodiment 4 according to the present invention; and

FIG. 10 is a flow diagram showing an operation according to Embodiment 4 of the present invention.

### BEST MODE FOR CARRYING OUT THE INVENTION

### Embodiment 1

FIG. 1 is a block diagram illustrating a navigation apparatus according to Embodiment 1 of the present invention. Own-vehicle location determination means 1 determines a location of the own-vehicle based on positional information from a global positioning system (GPS) 2 for receiving positional information transmitted from GPS satellites and on vehicle speed information from a vehicle speed sensor 3, and by means of a gyro-sensor, map matching, and the like. Data entering means 4—configured with a touch sensitive screen mounted on displaying means 5 such as a crystal panel, a remote control unit and the like—acquires data entered by a user. The displaying means 5 displays thereon a map, an own-vehicle mark indicating a location of the own-vehicle on the map, a fuel consumption rate and the like. In addition, audio voices may be used in combination.

Vehicle data acquisition means 6 acquires, using a variety of sensors, vehicle's data—such as an amount of fuel consumed and a traveled distance, fuel consumption rate data, acceleration data, a degree of depression of an accelerator pedal and a degree of braking action, a vehicle roll and pitch angle, and differential elevation data—and also records a history of the acquired vehicle data in a vehicle database 7 and reads it therefrom. History data acquisition means 8 acquires a variety of histories such as the own-vehicle location, and user's manipulation of the data entering means, to record them in a history database 9 and read them therefrom. Map data acquisition means 10 acquires map data from a map database 11 having the map data recorded therein. Route searching means 12 calculates a route between a start location and a destination location based on the map DB 11. These databases are stored in a hard disk drive (HDD) or a memory device.

Data processing means 13, which is configured with a central processing unit (CPU), a memory device and the like, processes a variety of data to thereby vary the own-vehicle mark. The variety of data includes the own-vehicle location data from the own-vehicle location determination means 1, the vehicle data from the vehicle data acquisition means 6, the history from the history acquisition means 8, the map data from the map data acquisition means 10, the route data from the route searching means 12, and the user's entered data from the data entering means 4. By the user's manipulation of the screen, graphs representing the history of detailed vehicle data are also created. At that time, a shape, color, style and the like of the own-vehicle mark is varied by determining the driving condition using the vehicle data. In particular, based on fuel consumption rate data if used as vehicle data, an energy-saving driving condition can be determined in consideration of the environment and resources. Thus, the own-vehicle mark is varied in line with the rate data. Further, since the fuel consumption rate can be approximately calculated by also using other data of the vehicle, the energy-saving driving condition can be similarly determined, to thereby vary the own-vehicle mark. The displaying means 5 displays this own-vehicle mark at the own-vehicle's location on the map data, and displays a graph or the like representing the history of the vehicle data. In this way, this navigation apparatus indicates the driving condition of the vehicle by means of the own-vehicle mark.

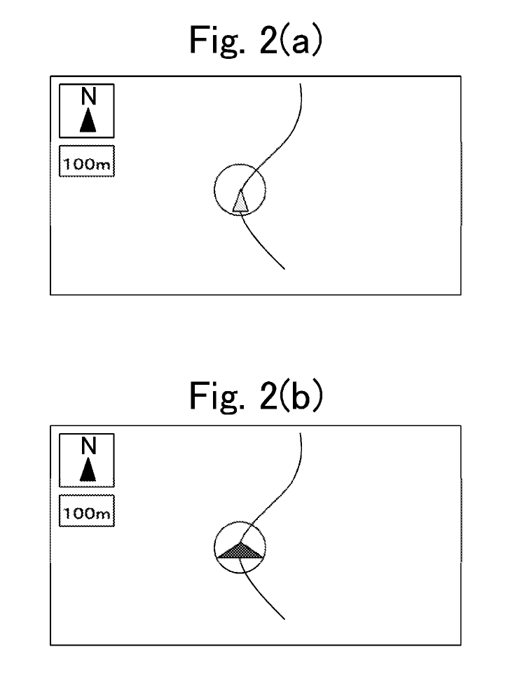

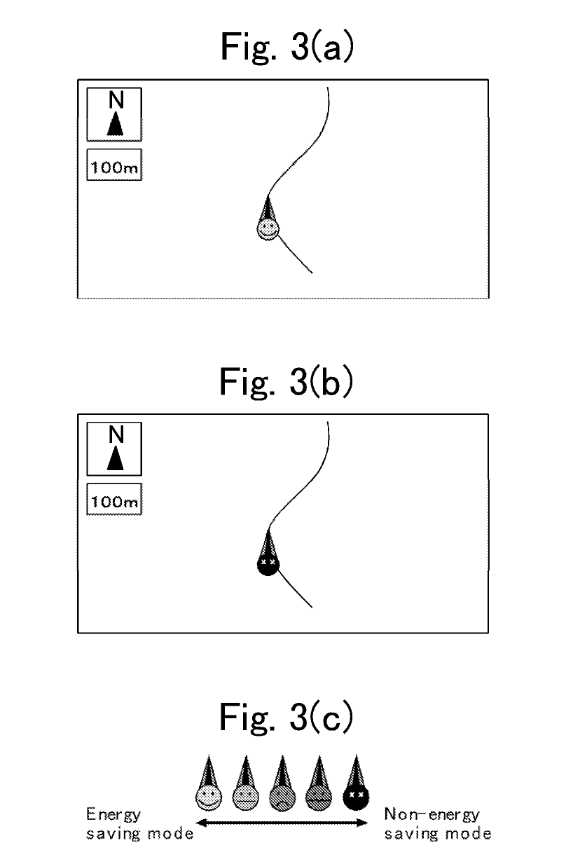

For example, shown in the center portion of FIG. 2(a) is an own-vehicle mark formed with a circle and a triangle. The apex of the triangle located in the center of the circle represents the location of the own-vehicle on a map, and the direction of the triangle apex is a direction in which the vehicle is traveling. With this situation, when fuel consumption rate data is used as vehicle data and if the present fuel consumption rate exceeds an average fuel consumption rate, the own-vehicle mark extends in size in terms of the bottom side of triangle in the circle and also varies in color, as shown in FIG. 2(b). FIG. 3 shows another example of the own-vehicle mark formed by a triangle and a circle located at the bottom of the triangle. The triangle apex represents the vehicle's present location, and a direction in which the triangle apex points is one in which the vehicle is traveling. FIG. 3(a) shows an own-vehicle mark during energy-saving driving. When the fuel consumption rate becomes worse, the own-vehicle mark varies in style and color as shown in FIG. 3(b). The mark may have multiple styles and colors as shown in FIG. 3(c), to vary in response to the fuel consumption. In particular, it will generally suffice if during energy-saving driving, the color of the own-vehicle mark is a green or bluish color, which is indicative of ecology, or a light or whitish color. Conversely, while the fuel consumption rate is worse, colors such as a reddish color, which is the attention-drawing color, or a darkened color, or a blackish color, are easy to recognize. For average rate driving, it is suitable if neutral colors are used. From a time of the good fuel consumption rate over to a time of the bad fuel consumption rate, for instance, green, yellowish green, yellow, orange and red, in that order would be easy to perceive.

The color, shape and style of the own-vehicle mark are changed here so that the mark does not partially hide or block the map display; however, the size of the mark may be varied so long as the mark itself does not interfere with the map display.

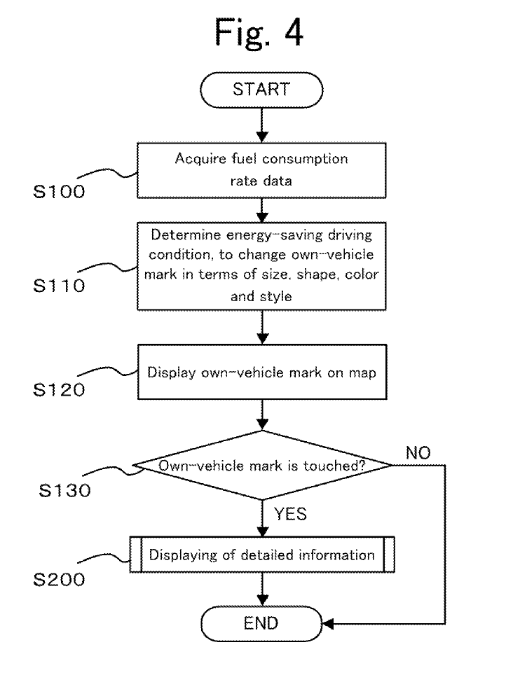

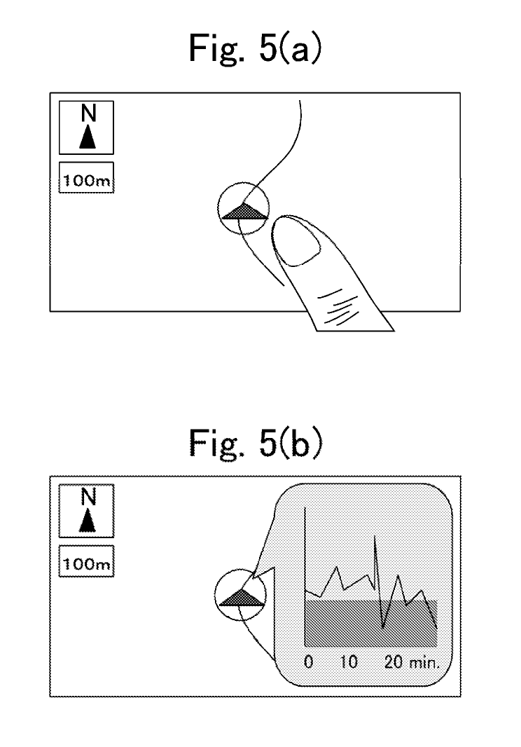

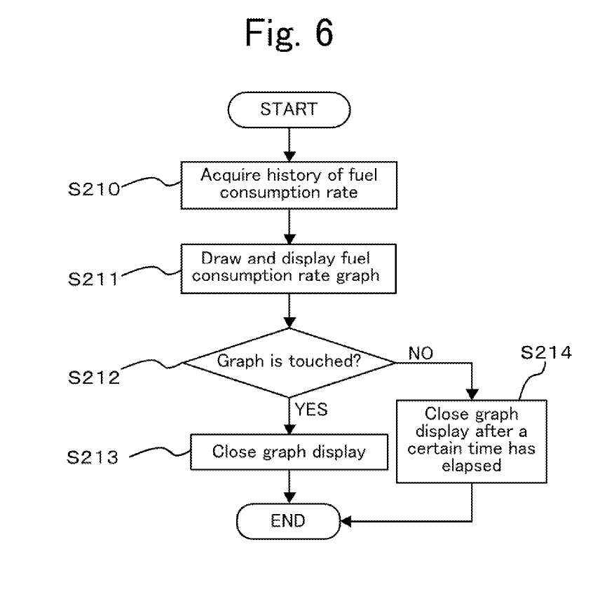

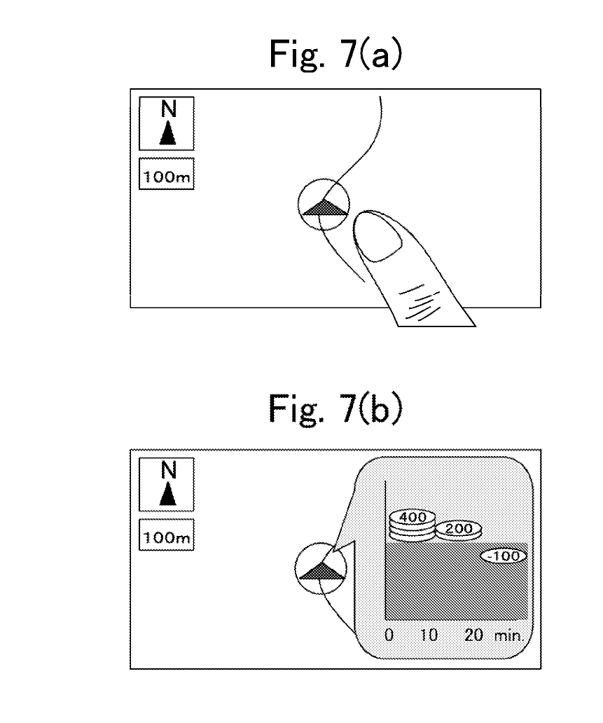

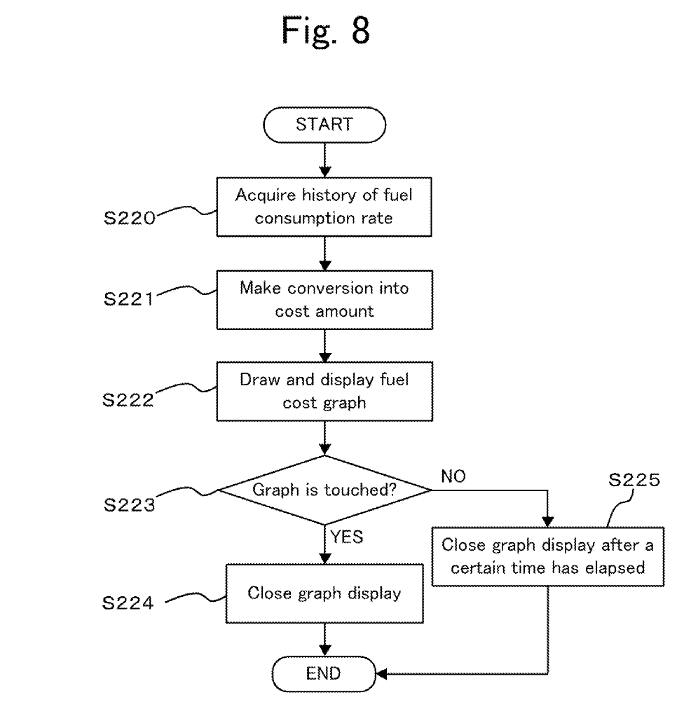

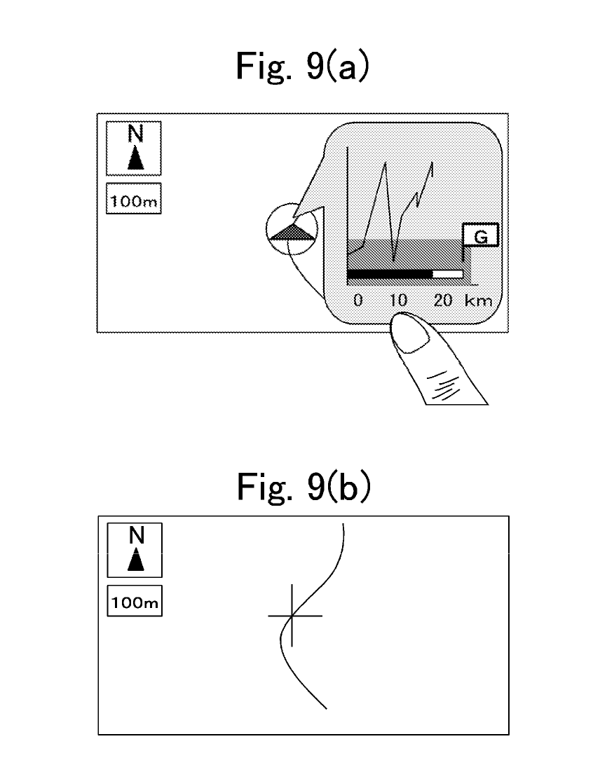

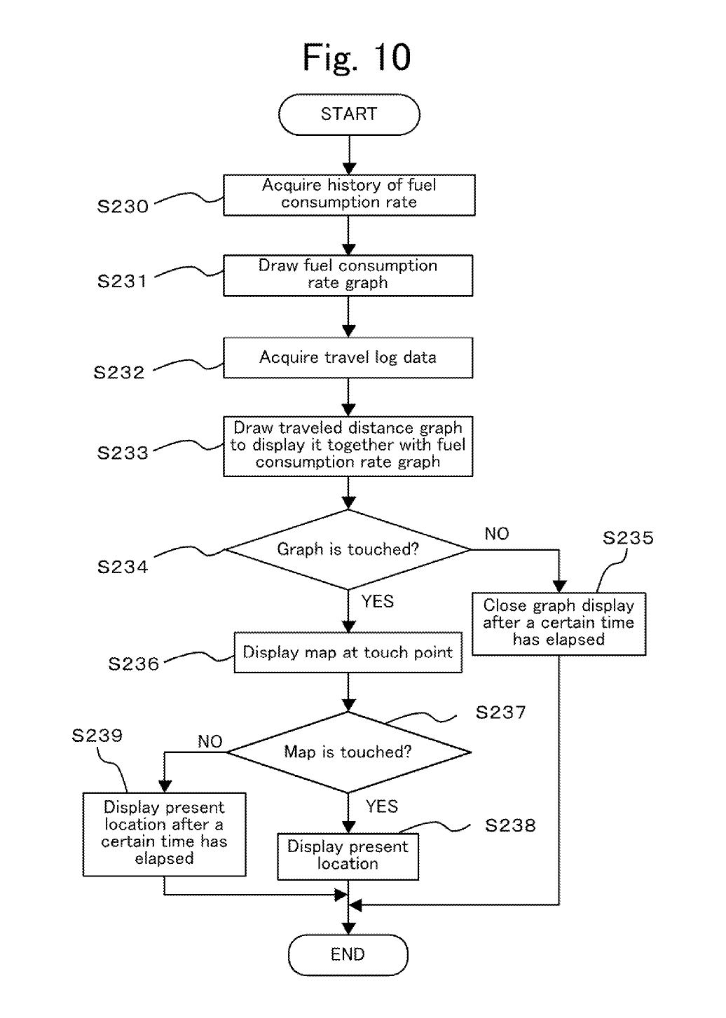

The operation of the vehicle-mounted information apparatus, thus configured, will be described based on a flow diagram of FIG. 4. First, the vehicle data acquisition means 6 acquires fuel consumption rate data (step S100). Next, in accordance with the present fuel consumption rate, the data processing means 13 evaluates the energy-saving driving condition. The condition can be categorized into, for instance, two ranks, “good” and “bad,” or can be ranked into three levels, “good,” “normal,” and “bad,” or into several levels including their intermediate levels, in comparison with the preset, average fuel consumption. Thereafter, in line with the level of the energy-saving driving condition, the own-vehicle mark varies in size, shape, color and style, for instance, as shown in FIG. 3(c) (step S110). Subsequently, the map data having the changed own-vehicle mark superimposed thereon is displayed on the screen of the displaying means 5 (step S120).

Thereafter, whether a user has touched the own-vehicle mark is determined (step S130). If the mark has been touched, detailed information such as a fuel consumption rate may be displayed as traveling information, as will be described later (step S200).

While the energy-saving driving condition is determined here using fuel consumption rate data derived from the vehicle, the fuel consumption rate may be calculated using an amount of fuel consumed, and a traveled distance, derived from the vehicle. In this case, the calculation mode of the fuel consumption rate can be varied for each certain range or each certain time interval, thus enabling calculation of the average fuel consumption rate and the like.

Further, the driving condition may be determined using acceleration data derived from an acceleration sensor. In other word, since the fuel consumption rate tends to decrease during acceleration, and tends to improve the fuel consumption rate during constant-speed operation involving no acceleration, the driving conditions can be determined based on these tendencies, thereby ranking them. The use of this ranking method can reduce a time lag for calculating the fuel consumption rate during acceleration, and upon the start of acceleration, the own-vehicle mark varies, which notifies the user that the energy-saving driving condition has become worse. Likewise, the degree of depression of the accelerator pedal and the degree of braking action may be detected to determine the driving condition because each condition of acceleration, constant-speed operation and deceleration becomes apparent from those detected data. Further, the traveling conditions, such as up-slope, down-slope, right and left turn may be calculated from sensor data for calculating a vehicle roll and pitch angle, to determine the driving condition. In other words, the fuel consumption rate tends to decrease on an up-slope travel, and to be improved on a down-slope travel. The fuel consumption rate also tends to decrease by acceleration/deceleration during right or left-turn. The driving conditions are ranked using such tendencies. In a similar way, since whether the vehicle is on the up-slope or down-slope can be determined from the differential elevation data, the driving condition may be determined using such data. From these data, the traveling conditions such as acceleration, constant-speed operation, deceleration, right/left-turn, and on-slope condition can be sensed, based on which the driving condition can be determined. In those determinations, the fuel consumption rate data is not handled directly, thus lacking the accuracy of a calculation; however, an approximately calculated fuel consumption rate can be used as an indicator for energy-saving driving, thus enabling the condition of energy-saving driving to be determined to thereby rank it. And a combination of these data can increase the accuracy of the calculation.

Since the navigation apparatus thus configured has a feature of varying the shape, size, color, and style, of the own-vehicle mark in agreement with the driving conditions, the marks do not interfere with or hide the map display. For that reason, the driving condition of the vehicle can be recognized without making it difficult to view a map display, thereby providing a navigation apparatus having enhanced convenience.

When the fuel consumption rate is calculated by using, as the vehicle data, the amount of fuel consumed and traveling distance, the fuel consumption rate data, the acceleration data, the degree of depression of the accelerator pedal and degree of braking action, the vehicle roll and pitch angle, and the differential elevation data, the fuel consumption rate calculated from those data is an indicator for the energy-saving driving. Thus, the level of energy-saving driving condition can be determined. Since the own-vehicle mark is varied in line with the calculation result, the user can readily recognize the energy-saving driving condition.

### Embodiment 2

In Embodiment 1 the size, shape, color, style of the own-vehicle mark is varied according to the amount of fuel consumption and the like; however, in an navigation apparatus according to Embodiment 2, the own-vehicle mark also serves as a portal button that allows detailed information to be easily accessed, and by touching the own-vehicle mark, traveling information is displayed which shows a detailed history of fuel consumption rate and the like.

The apparatus configuration here is the same as that in FIG. 1, and the basic flow diagram is also the same as that in FIG. 4; however, the following action will be taken in the detailed information displaying process (step S200) implemented after the own-vehicle mark has been touched in step S130 of FIG. 4.

First, touching of the own-vehicle mark by the user, as shown in FIG. 5(a), causes the data entering means 4 to select the mark. Consequently, the data processing means 13 acquires the history of the fuel consumption rate from the vehicle DB 7 via the vehicle data acquisition means 6, as shown in FIG. 6 (step S210). Next, assuming a start time to be zero minutes, a fuel consumption rate graph is drawn, as travel information, in which the history of the fuel consumption rate is plotted along the vertical axis, with an elapsed time period from the starting time until the present time taken along the horizontal axis, and then this traveling information is displayed on the displaying means 5, as shown in FIG. 5(b) (step S211). In this graph, the dark gray portion indicates that the fuel consumption rate is bad.

Thereafter, whether the graph is touched is determined (step S212). If it is touched, the graph window closes and the normal navigation display screen returns (step S213). Even if it remains untouched, the graph window closes automatically after a certain time has elapsed, so that the screen display is returned to the navigation screen (step S214). These processes can prevent the screen display from becoming difficult to view.

The travel information provided here employs a graph representing the history of the fuel-consumption rate with respect to an elapsed time; however, the graph may be replaced with a table. Although derived from the vehicle DB 7, the history of the fuel consumption rate may be calculated by reading from the vehicle DB 7 an amount of the fuel consumed and a history of the traveled distance.

Further, by reading a history of acceleration data from the vehicle DB 7, a graph representing the travel information may be drawn with acceleration plotted along the vertical axis and an elapsed time taken along the horizontal axis. And another graph representing traveling information may be drawn such that the degrees of acceleration and deceleration are plotted along the vertical axis by reading therefrom a degree of depression of the accelerator pedal and a degree of braking action. Another graph may be drawn such that the vehicle (road surface) roll and pitch angle is plotted along the vertical axis by reading therefrom histories of the vehicle roll and pitch angle and differential elevation data. As described in Embodiment 1, use of these data enables approximate calculation of the fuel consumption rate; thus, a graph of fuel consumption rate using the approximate calculation can also be drawn with respect to an elapsed time.

Another graph representing the travel information, having a fuel consumption rate along the vertical axis with a traveled distance taken along the horizontal axis, can be displayed by reading the history of the traveled distance and the history of the fuel consumption rate from the vehicle DB 7. With respect to the traveled distance along the horizontal distance, the graph may display along the vertical axis not only the fuel consumption rate, but also the vehicle data such as the acceleration and the vehicle roll and pitch angle, as described above.

In the navigation apparatus thus configured, a graph or a table representing the history of vehicle data such as detailed fuel consumption rate with respect to an elapsed time and a traveled distance, is displayed as travel information by touching the own-vehicle mark. As a result, the travel information can be displayed only when the user needs it, which prevents the screen display from becoming difficult to view, thereby providing the navigation apparatus having enhanced convenience for the user.

### Embodiment 3

In Embodiment 2, it is described that the travel information of the history such as the detailed fuel consumption rate is displayed by touching the own-vehicle mark; however, in Embodiment 3, a navigation apparatus will be described in which the conversion of a fuel consumption rate into a cost amount provides a user with increased realism, thus developing awareness of the energy-saving driving.

The configuration of the apparatus here is the same as that in FIG. 1 and the basic flow diagram is also the same as that in FIG. 4; however, the following action will be taken in the detailed information process (step S200) to be implemented after the own-vehicle mark has been touched in step S130 of FIG. 4.

First, touching of the own-vehicle mark by the user, as shown in FIG. 7(a), causes the data entering means 4 to select the mark. Consequently, the data processing means 13 acquires the history of the fuel consumption rates from the vehicle DB 7 via the vehicle data acquisition means 6, as shown in FIG. 8 (step S220). Based on the history of the fuel consumption rates, the fuel consumption rate is converted into a cost amount for each certain time interval, with an amount of cost saved being marked by a positive sign when the present fuel consumption rate is improved more than the average one, and with an excessive amount of cost used being marked by a negative sign when the fuel consumption rate becomes worse than the average one (step S221). The cost amount is calculated from a unit price value of fuel such as gasoline and an amount of fuel consumption. With a typical unit price value of the fuel entered into the apparatus, the unit price value may be used for approximate calculation, while a way may be used such that every time the vehicle is refueled, a unit price value and a refueled amount are entered thereinto to accurately calculate the cost amount. After that, assuming a start time to be zero minutes, a cost graph is drawn as travel information with the cost amount for each certain time interval plotted along the vertical axis, and an elapsed time from the start time until the present time taken along the horizontal axis. And this travel information is displayed on the displaying means 5 (step S222). At this time, the cost amount may be shown with a stack of banknotes, or coins. FIG. 7(b) illustrates an example of a window representing the coins. In this graph, the darker gray portion shows that the fuel consumption rate is bad, with the coin being represented as a negative value.

Thereafter, it is determined whether the graph is touched (step S223), and if it is touched, then the graph window closes, and the normal navigation screen returns (step S224). Even if it remains untouched, the graph window closes automatically after a certain time has elapsed, so that the screen display is returned to the navigation screen (step S225). These processes can prevent the screen display from becoming difficult to view.

The travel information may also be provided here in a table as with Embodiment 2. A graph representing a cost amount may also be used in which the histories of the amount of fuel consumed and the traveled distance are read from the vehicle DB 7, to calculate the history of fuel consumption rates and then make conversion of a fuel consumption rate into a cost amount. Another graph representing the cost amount may be drawn in which the history of acceleration data, the degree of depression of accelerator pedal and degree of braking action, the vehicle roll and pitch angle and the differential elevation data are read from the vehicle, to approximately calculate the fuel consumption rate using those data, whereby the history of fuel consumption rates is acquired to make conversion to the cost amount. Another graph representing travel information can be drawn in which the history of the traveled distance from the starting location is read from the vehicle DB 7, whereby the cost amount is plotted along the vertical axis, with the traveled distance taken along the horizontal axis.

In the navigation apparatus thus configured, touching of the own-vehicle mark causes the travel information to be displayed by being converted into a cost amount represented as a stack of banknotes, coins or the like, thus providing a user with increased realism and developing more awareness of the energy-saving driving. The travel information converted into the cost amount can be displayed only when the user needs it, thus providing the navigation apparatus having enhanced convenience for the user.

### Embodiment 4

In Embodiment 1 and Embodiment 2, the travel information showing the history of fuel consumption rates and the like is displayed by selecting the own-vehicle mark, while in a navigation apparatus according to Embodiment 4, a map of the selected location is displayed by further selecting a graph or a table of the travel information.

The apparatus configuration here is the same as that in FIG. 1, and the basic flow diagram is the same as that in FIG. 4; however, the following action will be taken in the detailed information displaying process (step S200) to be implemented after the own-vehicle mark has been touched in step S130 of FIG. 4.

First, touching of the own-vehicle mark by the user causes the data entering means 4 to select the mark. Consequently, the data processing means 13 acquires the history of the fuel consumption rates and the traveled distance from the vehicle DB 7 via the vehicle data acquisition means 6, as shown in FIG. 10 (step S230). Next, assuming a start location to be zero kilometers, a fuel consumption rate graph is drawn, as travel information, in which the history of fuel consumption rates is plotted along the vertical axis with an elapsed time from the start time until the present time taken along the horizontal axis and (step S231). Thereafter, travel log data showing a location of the own-vehicle is acquired from the history DB 9 via the history acquisition means 8 (step S232). If the route is established, a travel distance graph may be drawn in which a current distance traveled is shown with respect to a total distance to a destination location, and may be displayed on the displaying means 5 together with the fuel consumption rate graph, as shown in FIG. 9(a) (step S233). In this fuel consumption rate graph, the dark gray portion shows that the fuel consumption rate is bad. A travel distance to the destination location is shown by a single horizontal bar-graph where its black portion shows a traveled portion of the route and its white portion, a non-traveled portion thereof.

Next, it is determined whether an arbitrary portion on the graph of the travel information is touched (step S234). If it remains untouched and when the graph window closes after a certain time of period has elapsed, a present location of the own-vehicle is displayed (step S235). If it is touched, data for a past location of the own-vehicle, recorded when it has traveled in a location corresponding to the selected portion, is derived from the history DB 9, and map data indicating the past location of the own-vehicle is then acquired from the map DB 11, thereby displaying this map on the displaying means 5 (step S236). For instance, in the case of FIG. 9(a), the fuel consumption rate at a location of 10 km takes a downturn, and the touching of this portion causes a map corresponding to the location to be displayed as shown in FIG. 9(b). This allows for estimation of a possible cause of the reduced fuel consumption rate, thus leading to the energy-saving driving.

Thereafter, whether the map is touched is determined (step S237), and if it is touched, the map window closes and the vehicle's present location is displayed and then the normal navigation mode screen returns (step S238). Even if it remains untouched, after a certain time has elapsed, the map window closes automatically and the present location is displayed and then the navigation screen returns (step S239). These processes can prevent the screen display from becoming difficult to view.

The graph representing the history of the fuel consumption rates with respect to the traveled distance is used here; however a table may be used instead. Along the horizontal axis is the traveled distance here; however, the traveled time may be taken instead. Further, the graph may be such that the cost amount converted from the fuel consumption rate is plotted along the vertical axis, or such that the vehicle data such as acceleration and vehicle roll and pitch angle is plotted therealong. When the user selects a certain portion in travel information contained in these graphs and table, it will generally suffice if the past own-vehicle location corresponding to the selected portion is derived from the history DB 9, the map data of the past own-vehicle location is next acquired from the map DB 11, and then the map is displayed on the displaying means 5.

In a navigation apparatus thus configured, by touching an arbitrary location in the travel information, the corresponding map is displayed, which enables estimation of a possible cause of changing fuel consumption rates and the like, thus providing navigation apparatuses that can lead to more energy-saving driving. In addition, the travel distance graph is also displayed together with the fuel consumption rate graph by touching the own-vehicle mark, whereby a degree of the progress on the way to destination of the route can be recognized, thus providing enhanced convenience.

### REFERENCE NUMERALS

1. Own-vehicle location determination means
2. GPS
3. Vehicle speed sensor
4. Data entering means
5. Displaying means
6. Vehicle data acquisition means
7. Vehicle database
8. History data acquisition means
9. History database
10. Map data acquisition means
11. Map database
12. Route searching means
13. Data processing means

1. A navigation apparatus comprising:
an own-vehicle location determination unit that determines a location of an own vehicle;
a map database having map data recorded therein;
a vehicle data acquisition unit that acquires vehicle data;
a display unit that displays on the map data an own-vehicle mark indicating the location of the own vehicle; and
a data processor that determines a driving condition using the vehicle data, to thereby vary the own-vehicle mark,
wherein a traveling condition is represented by manipulation of the own vehicle mark.

2. (Canceled)

3. The navigation apparatus as recited in claim 1, wherein the data processor determines the driving condition using, as the vehicle data, at least one of an amount of fuel consumed and a traveled distance, fuel consumption rate data, acceleration data, a degree of depression of an accelerator pedal and a degree of braking action, a vehicle roll and pitch angle, and differential elevation data.

4. The navigation apparatus as recited in claim 3, wherein the data processor calculates a fuel consumption rate from the vehicle data, to determine a condition of an energy-saving driving of the vehicle from the fuel consumption rate.

5. The navigation apparatus as recited in claim 1, further comprising a data entering unit; and a vehicle database that records a history of the vehicle data, wherein, if the own-vehicle mark is selected using the data entering unit, the data processor reads the history of the vehicle data from the vehicle database, and then displays, as the travel information, on the display unit the history of the vehicle data or a cost amount converted from a fuel consumption rate calculated from the history thereof, the history and the cost amount corresponding to a traveled time or a traveled distance.

6. The navigation apparatus as recited in claim 5, further comprising a history database that records the history of the vehicle data, wherein, if the travel information is selected using the data entering unit, the data processor calculates from the history database a past own-vehicle location that corresponds to a selected portion of the travel information, to acquire map data of the past own-vehicle location from the map database and then display the map data thereof onto the display unit.
